(19) United States
(12) Patent Application Publication
(10) Pub. No.: US 2007/0129079 A1
(43) Pub. Date: Jun. 7, 2007

(54) Method for the allocation and release of channels in a mobile communication system

(75) Inventors: Uwe Schwarz, Veikkola (FI); David Bohaty, Prague (CZ)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/634,075

(22) Filed: Dec. 6, 2006

(30) Foreign Application Priority Data
Dec. 7, 2005 (FI) 20051263

(51) Int. Cl. H04Q 7/20

(52) U.S. Cl. 455/450

(57) ABSTRACT

The invention relates to a method for the allocation and release of channels in a communication system. A first session is established associated with the first mobile node via a radio node and a call control node to a conversation state. The establishment of a second session associated with a second mobile node is started in the same cell. The lack of available channels in the cell is determined in association with the second session. The first session is selected for dropping based on information on the session within the cell. The first session is released in response to the selection. Thereupon, the channel thus made available is allocated for the second session in the radio node.

### BACKGROUND OF THE INVENTION

1. Field of the Invention

The invention relates to call set-up in mobile communication systems. Particularly, the invention relates to a method for the allocation and release of channels in a mobile communication system.

2. Description of the Related Art

Previously in mobile communication systems radio channel allocation has been based on equal treatment of subscribers. In the case of congestion radio channels have been queued in a straightforward first-in-first-out basis. There has been no segregation of subscribers. However, there has arisen a need to be able to provide affordable communication services for subscribers with limited means. Often such subscribers are willing to make concessions in terms of the reliability of their services. In exchange for more affordable prices some disruptions are not considered an issue. On the other hand, in addition to subscribers with limited means there are subscribers who are willing to pay substantially higher prices for reliable high-priority communication services.

Reference is now made to FIG. 1, which illustrates a Global System of Mobile Communications (GSM) or a Universal Mobile Telecommunications System (UMTS) network in prior art. The communication system comprises at least a Mobile Station (MS) 100, a serving MSS 120, a gateway MSS 130, a Home Location Register (HLR) 132, a Camel Service Entity (CSE) 134, a Base Station Controller (BSC) 114 and an access network 110 connected to a Base Transceiver Station (BTS) 112. Serving MSS 120 comprises a Visitor Location Register (VLR) 122, which stores subscriber data for subscribers currently registered in serving MSS 120. Gateway MSS 130 has a signaling connection to a Public Switched Telephone Network (PSTN) 140 and to serving MSS 120. Gateway MSS 130 controls a second MGW 118 and MSS 120 controls a first MGW 116. Second MGW 118 is connected to PSTN 140 for the purpose of mobile terminated calls and provides user plane conversion to/from circuit switched E1/T1 to IP packets. First MGW 116 is connected to PSTN 140 for mobile originated calls and provides user plane conversion to/from circuit switched BSC 114 to IP packets. Packets are routed between first MGW 116 and second MGW 118 based on requests from MSS 120 and MSS 130, respectively. BSC 114 is connected to MSS 120 using protocol interface 154. Protocol interface 154 is, for example, a GSM A/Gb-interface or a UMTS Iu-interface. BSC 114 may thus also be a UMTS Radio Network controller.

Reference is now made to FIG. 2, which illustrates priority pre-emption in a Global System of Mobile Communications (GSM) or a Universal Mobile Telecommunications System (UMTS) network in prior art. The priority pre-emption in GSM and UMTS is specified in the 3G Partnership Project (3GPP) specification 24.067. The architecture of a GSM/EDGE/UMTS network is disclosed in the 3GPP specification 23.002. The GSM and the UMTS provide a priority-based preemption mechanism where an existing call may be cleared out of the way of a higher priority call. In FIG. 2 there is shown a radio interface 240 of a cell provided by BTS 112. Radio interface 240 provides a number of communication channels. Some channels are common channels and some dedicated channels. The bi-directional traffic channels provided by radio interface 240 for the carrying of speech are illustrated with a box 242. Box 242 illustrates the current allocation of traffic channels. The allocation of a first, a second and a third traffic channel is illustrated with boxes 244, 246 and 248, respectively. Boxes 244-248 illustrate the traffic channels and the text within each box illustrates the current owner of the traffic channel. The information within box 240 is actually maintained by BSC 114, which performs the allocation of radio resources.

In FIG. 2 there are four mobile stations, namely, mobile station M1, M2, M3 and M4. The traffic channel allocation for mobile stations M1, M2 and M3 is illustrated with lines 254, 256 and 258, respectively. The starting point in FIG. 2 is that mobile stations M1, M2 and M3 have stable two-party calls in speech state. However, mobile station M4 also needs to establish a call and requires a traffic channel. The call is assumed to be a call of higher priority than any of the calls associated with mobile stations M1, M2 and M3. The call to be established is assumed to be an emergency call or a call established by an authority. As illustrated with arrow 201, mobile station M4 sends a call set-up request to BTS 112 via a signaling channel. The signaling channel has been allocated via a random access channel. At step 202 the call set-up request arrives at BSC 114, from which it sent forward towards MSS 120. At some stage in call set-up, a speech traffic channel is required and BSC must clear one of the calls associated with mobile stations M1, M2 and M3. As illustrated with arrow 203, BSC 114 determines that channel allocations 244, 246 and 248 have lower priorities (not shown) than the call to be established for mobile station M4. Therefore, BSC 114 selects randomly one of the lower priority channel allocations. In FIG. 2, BSC 112 selects traffic channel 244, which entails that the call for mobile station M3 is cleared. BSC 112 replaces the allocation for mobile station M3 with the allocation for mobile station M4.

Another similar prior art pre-emption mechanism, however, for the fixed networks is disclosed in Internet Engineering Task Force (IETF) document RFC 794. The preemption mechanism is based on a priority of user stations.

There are a number of problems involved in the prior art GSM and UMTS priority preemption mechanism. Firstly, the call to be cleared ahead of a higher-priority call is chosen randomly without knowledge of the duration of the cleared call in relation to other calls in the cell. Secondly, the lower priority call is cleared without a grace period and an alert indicating the start of a grace period. Thus, there is no time for the parties of the call to be cleared to agree on the continuation of the call later on. Thirdly, the preempting call must actually have a higher priority than the cleared calls. Duration based preemption within the same priority class that gives priority for new calls over existing calls that have exceeded a minimum time is not possible. Further, it should be noted that without a graceful release and without a duration based selection of the preempted call, the preemption would become somewhat random and would not be distinguishable for the subscribers from call drops due to bad radio conditions or failures. These problems together render the prior art solution unsuitable for a charge-based prioritization. At least some of the problems listed herein should be alleviated in order to implement a charge-based prioritization.

### SUMMARY OF THE INVENTION

The invention relates to a method for the allocation and release of channels in a communication system comprising at least a first mobile node, a second mobile node, a session control node and a radio node. The method comprises establishing a first session associated with said first mobile node via said radio node and said session control node to a conversation state, said first session using a first channel within a first cell; starting the establishment of a second session associated with said second mobile node in said first cell; determining in said radio node the lack of available channels in said first cell for said second session; selecting in said session control node said first session for dropping; providing a warning signal to at least one party associated with said first session; releasing said first session; and allocating said first channel for said second session in said radio node.

The invention relates also to a method for the allocation and release of channels in a communication system comprising at least a first mobile node, a second mobile node, a session control node and a radio node. The method comprises establishing a first session associated with said first mobile node via said radio node and said session control node to a conversation state, said first session using a first channel within a first cell; recording an allocation time for said first session in said session control node; starting the establishment of a second session associated with said second mobile node in said first cell; determining in said radio node the lack of available channels in said first cell for said second session; comparing the allocation time for said first session to the allocation time for at least one third session in said session control node; if the allocation time of said first session is longer than the allocation time of said at least one third session, selecting in said session control node said first session for dropping; releasing said first session; and allocating said first channel for said second session in said radio node.

The invention relates also to a system comprising a session control node configured to establish a first session associated with a first mobile node to a conversation state, said first session using a first channel within a first cell, to receive an indication of the establishment of a second session associated with a second mobile node in said first cell, to receive an indication of the lack of an available channel in said first cell for said second session, to request a warning signal to at least one party associated with said first session in response to said indication, to select said first session for dropping, to release said first session and to allocate said first channel for said second session.

The invention relates also to a system comprising a session control node configured to establish a first session associated with said first mobile node to a conversation state, said first session using a first channel within a first cell, to record an allocation time for said first session, to start the establishment of a second session associated with a second mobile node in said first cell, to receive an indication of lack of available channels in said first cell for said second session, to compare the allocation time for said first session to the allocation time for at least one third session, to select said first session for dropping in response to the allocation time of said first session indicating longer time than the allocation time of said at least one third session, to release said first session and to allocate said first channel for said second session via a radio node.

The invention relates also to a network node comprising a call control entity configured to establish a first session associated with a first mobile node to a conversation state, said first session using a first channel within a first cell, to receive an indication of the establishment of a second session associated with a second mobile node in said first cell, to receive an indication of lack of available channels in said first cell for said second session, to request a warning signal to at least one party associated with said first session in response to said indication and to release said first session; and a pre-emption entity configured to select said first session for dropping based on information on said first cell.

The invention relates also to a network node comprising a call control entity configured to establish a first session associated with said first mobile node to a conversation state, said first session using a first channel within a first cell, to start the establishment of a second session associated with a second mobile node in said first cell, to receive an indication of lack of available channels in said first cell for said second session, to release said first session and to allocate said first channel for said second session via a radio node; and a pre-emption entity configured to record an allocation time for said first session, to compare the allocation time for said first session to the allocation time for at least one third session, to select said first session for dropping in response to the allocation time of said first session indicating longer time than the allocation time of said at least one third session.

The invention relates also to a network node comprising means for establishing a first session associated with a first mobile node to a conversation state, said first session using a first channel within a first cell; means for receiving an indication of the establishment of a second session associated with a second mobile node in said first cell; means for determining the lack of available channels in said first cell for said second session; means for selecting said first session for dropping; means for releasing said first session; and means for allocating said first channel for said second session.

The invention relates also to a network node comprising means for establishing a first session associated with said first mobile node to a conversation state, said first session using a first channel within a first cell; means for recording an allocation time for said first session; means for starting the establishment of a second session associated with a second mobile node in said first cell; means for receiving an indication of lack of available channels in said first cell for said second session means for comparing the allocation time for said first session to the allocation time for at least one third session; means for selecting said first session for dropping in response to the allocation time of said first session indicating longer time than the allocation time of said at least one third session; means for releasing said first session; and means for allocating said first channel for said second session via a radio node.

The invention relates also to a computer program comprising code adapted to perform the following steps when executed on a data-processing system: establishing a first session associated with a first mobile node to a conversation state, said first session using a first channel within a first cell; receiving an indication of the establishment of a second session associated with a second mobile node in said first cell; determining the lack of available channels in said first cell for said second session; selecting said first session for dropping; releasing said first session; and allocating said first channel for said second session.

The invention relates also to a computer program comprising code adapted to perform the following steps when executed on a data-processing system: establishing a first session associated with said first mobile node to a conversation state, said first session using a first channel within a first cell; recording an allocation time for said first session; starting the establishment of a second session associated with a second mobile node in said first cell; receiving an indication of lack of available channels in said first cell for said second session comparing the allocation time for said first session to the allocation time for at least one third session; selecting said first session for dropping in response to the allocation time of said first session indicating longer time than the allocation time of said at least one third session; releasing said first session; and allocating said first channel for said second session via a radio node.

In one embodiment of the invention, the session control node and the radio node are the same node. In one embodiment of the invention, the session control node and the radio node are the separate nodes.

In one embodiment of the invention, the selecting of said first session for dropping is performed in response to an indication from said radio node, that the radio node has determined the lack of available channels in said first cell for said second session.

In one embodiment of the invention, the call control entity within the session control node allows the first session to continue a predefined time after the call control entity has requested said warning signal. The predefined time may also be calculated from the end of the warning signal. The session control node releases the first session in response to the elapsing of the predefined time. The predefined time is a grace period during which call parties may, for example, agree upon a continuation of the call in future. The predefined time may be, for example, 6 seconds.

In one embodiment of the invention, a first priority is determined for said first session. The priority is determined, for example, in subscription information stored in a Visitor Location Register (VLR) in association with a Mobile Switching center Server (MSS) or using an explicit priority indication carried in a call set-up message such as a number prefix. A second priority is determined for the second session. The second priority is also determined, for example, in subscription information stored in a Visitor Location Register (VLR) in association with a Mobile Switching center Server (MSS) or using an explicit priority indication carried in a call set-up message such as a number prefix. The first and second priorities are available to the MSS. The pre-emption entity in the MSS or the call control entity in the MSS checks that the second priority is equal to or higher than the first priority before selecting said first session for dropping.

In one embodiment of the invention, the preemption entity in the session control node determines that a priority for said first session does not exceed a predefined priority. Only if the priority is low enough, the session may be marked by the pre-emption entity in the cell specific session lists as a candidate for session drop. The pre-emption entity determines that the first session has exceeded a minimum session duration time and marks the session as a candidate for session drop. Thereupon, the pre-emption entity may, upon a request from the call control entity or a BSS signaling entity, drop the session in order to obtain a channel for the second session. In one embodiment of the invention, an allocation time for said first session is recorded in said session control node. The allocation time is recorded by the preemption entity based on call information provided by the call control entity. The call information indicates, for example, a timestamp for the allocation of a channel from the cell of the call. The allocation time for said first session is compared to the allocation time for at least one third session in said session control node and in said session control node is selected said first session for dropping, if the allocation time of said first session is longer than the allocation time of said at least one third session. The selection is performed by the pre-emption entity. In one embodiment of the invention, the allocation time comprises a timestamp indicating the time a channel was allocated for said session in a given cell. The given cell may be the first cell or a different cell from which the session was handed over to the first cell.

In one embodiment of the invention, the allocation time comprises a time indicating the duration of said session. The duration of a session may be measured by the call control entity or the pre-emption entity from the time a channel was allocated for the session or from the time the session entered a two-party conversational state, for example, from the time the session was answered. In one embodiment of the invention, the pre-emption within the session control node records the duration of said first session. Upon receiving information on the second session, for which a channel must be allocated from the cell of the first session, the pre-emption entity compares the durations of the sessions, which have channels allocated from the same cell. Thus, the duration of the first session is compared to the duration of at least one third session in the session control node. The first session is selected for dropping, if the duration of the first session is longer than the duration of the at least one third session.

In one embodiment of the invention, a priority is set for the first session based on subscriber data associated with said first mobile node in a Visitor Location Register (VLR) in association with the session control node. The pre-emption entity in the session control node determines that the first session has exceeded a minimum session duration time. Thereupon, the priority for the first session is demoted in response to the exceeding of the minimum session duration time.

In one embodiment of the invention, the priority for said first session is demoted, that is, downgraded at least once in every predefined priority demotion period. The period may be, for example, 30 seconds or 1 minute. The purpose of the priority demotion period is to be indicative of desired minimum call duration for low priority subscribers and calls.

In one embodiment of the invention, a handover due to traffic conditions is performed for the first session. The priority for the first session is demoted by the call control in the session control node in response to the handover, if a second predefined time has elapsed. The second predefined time indicates, for example, the duration of the call or the time a channel has been allocated for the call from a given cell. The pre-emption entity marks the new priority to the session information associated with the cell of the first session.

In one embodiment of the invention, the communication system comprises a Wireless Local Area Network. The radio node may be a radio control node for the WLAN, which communicates with a number of WLAN base transceiver stations. The radio node may also be a WLAN base transceiver station. In one embodiment of the invention, the radio node is an Unlicensed Mobile Access (UMA) Controller (UNC), which acts as the Base Station Subsystem (BSS) towards a GSM/EDGE/UMTS core network. An UNC interfaces an IP network and a WLAN access point in the uplink direction towards the mobile node.

In one embodiment of the invention, the mobile communication system comprises at least one of a Global System of Mobile Communications network and a Universal Mobile Telephone System network. The radio node may comprise a Base Station Controller (BTS) or a Radio Network Controller (RNC).

In one embodiment of the invention, the session control node comprises a Mobile Service Switching center Server (MSS).

In one embodiment of the invention, the session control node comprises a Call State Control Function (CSCF) in association with an IP multimedia subsystem.

In one embodiment of the invention, the mobile node comprises a Subscriber Identity Module (SIM). The mobile node may be a mobile station comprising a mobile terminal and a SIM. The mobile node may be another type of mobile terminal without a separate SIM. The subscription may be defined on the memory of the mobile terminal.

In one embodiment of the invention, the mobile station is a multi-radio terminal, which is supports both WLAN and licensed band radio connectivity. Licensed band radio connectivity comprises, for example, Global System of Mobile communications (GSM) radio connectivity and Universal Mobile Telecommunication System (UMTS) connectivity on the radio bands that have been allocated for operators providing 2G and 3G service.

In one embodiment of the invention, the computer program is stored on a computer readable medium. The computer readable medium may be a removable memory card, magnetic disk, optical disk or magnetic tape.

In one embodiment of the invention, the term session refers also to any communication established between two parties, one of which is a mobile node. The session may be a connection, a call, a video call or any interactive or conversational multimedia data communication.

In one embodiment of the invention, a channel is a GSM/UMTS traffic channel. In one embodiment of the invention, the channel is in other words a transmission resource for transmitting data. Thus, a given transmission resource comprises at least one of a carrier frequency, a timeslot, a spreading code and a number of Orthogonal Frequency Division Multiplexing (OFDM) sub-carriers.

In one embodiment of the invention, a transmission resource comprises a number of adjacent Orthogonal Frequency Division Multiplexing (OFDM) sub-carriers. In one embodiment of the invention, a trans-mission resource comprises a number of evenly spaced Orthogonal Frequency Division Multiplexing (OFDM) sub-carriers. In one embodiment of the invention, a trans-mission resource comprises a number of evenly spaced clusters of adjacent Orthogonal Frequency Division Multiplexing (OFDM) sub-carriers. In one embodiment of the invention the transmission resource comprises a combination of at least two of a carrier frequency, a timeslot, a spreading code and an Orthogonal Frequency Division Multiplexing (OFDM) sub-carrier.

The benefits of the invention are related to the possibility of segmentation between subscribers. The subscribers may be provided with different priorities based on service agreement prices. It is possible to perform soft session dropping in order to make way for a higher-priority session or a new session with the same priority as the existing call. If required, it is also possible to ensure that sessions have lasted a predefined time before they are enabled for session dropping. The soft session dropping enables a new session to wait a short predefined period while the parties to the session to be cleared are be informed of the situation and may, for example, agree on continuing the session further at a later time.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating a Global System of Mobile Communications (GSM) or a Universal Mobile Telecommunications System (UMTS) network in prior art;

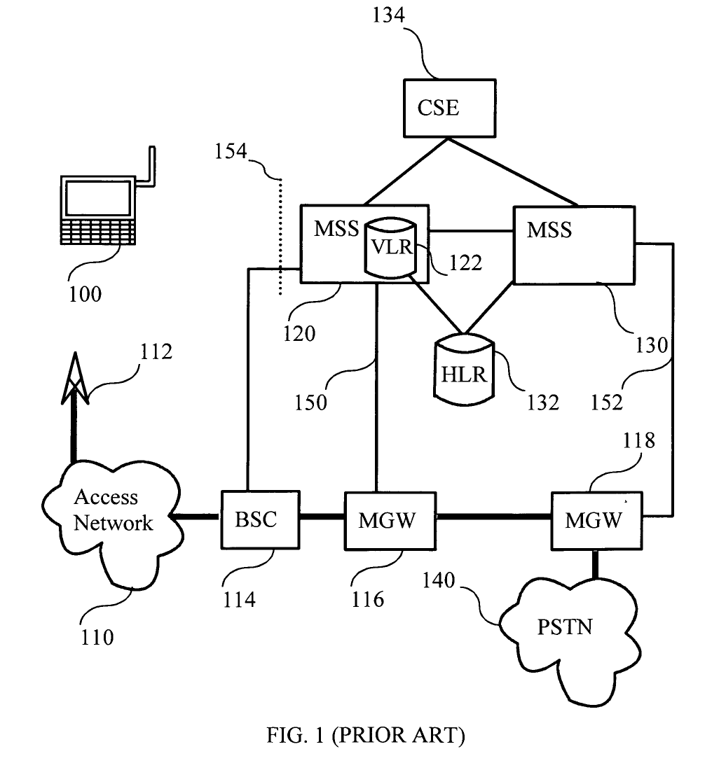

FIG. 2 is a block diagram illustrating priority preemption in a Global System of Mobile Communications (GSM) or a Universal Mobile Telecommunications System (UMTS) network in prior art;

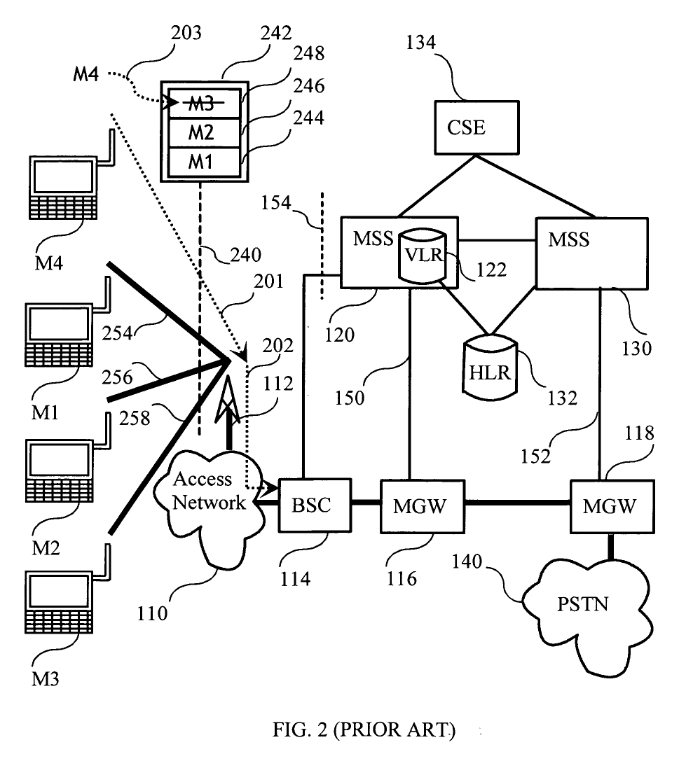

FIG. 3 is a message sequence chart illustrating a method for the allocation and release of channels in a mobile communication system in one embodiment of the invention;

FIG. 4 is a message sequence chart illustrating a method for channel pre-emption, that is, for channel release and allocation, in one embodiment of the invention; and

FIG. 5 is a block diagram illustrates a communication system employing the method for the allocation and release of channels in one embodiment of the invention.

### DETAILED DESCRIPTION OF THE EMBODIMENTS

Reference will now be made in detail to the embodiments of the present invention, examples of which are illustrated in the accompanying drawings.

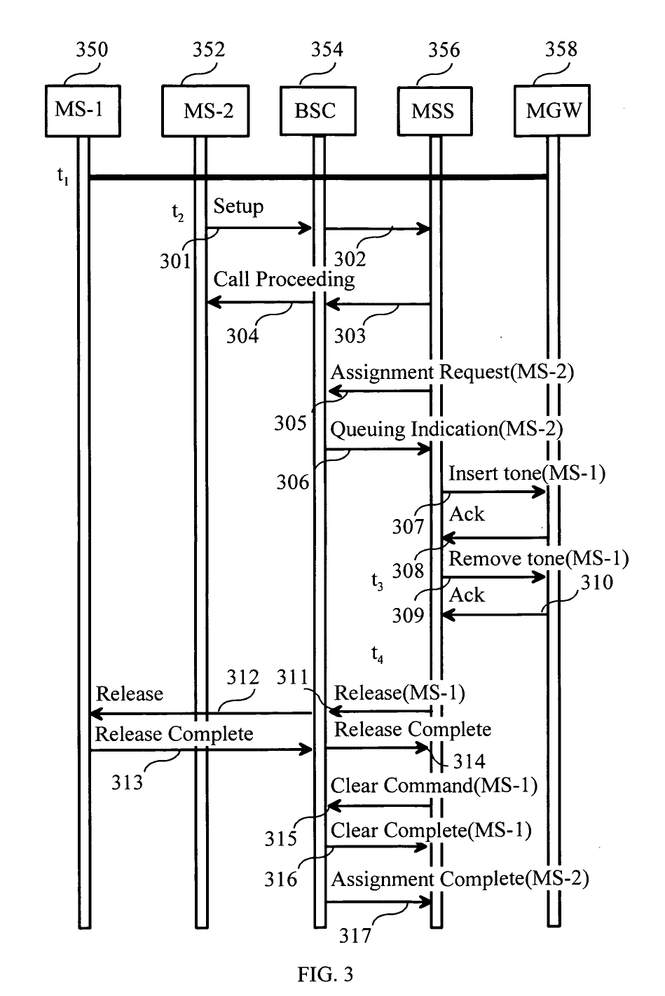

FIG. 3 is a message sequence chart illustrating a method for the allocation and release of channels in a mobile communication system in one embodiment of the invention. In FIG. 3 there is a mobile station 350, a mobile station 352, a Base Station Controller (BSC) 354, a Mobile Switching Center (MSC) Server (MSS) 356 and a Media Gateway (MGW) 358. At time to mobile station 350 has a first call in speech state with a bi-directional speech path towards a second call party via media gateway 358. As the first call had a traffic channel allocated for it by BSC 354 and the allocation was indicated to MSS 356, the information regarding first call and the cell used by the first call was stored by a pre-emption entity (not shown) in MSS 356. The pre-emption entity enables the selection of the best candidate for pre-emption based on call information. The call information may comprise, for example, the duration of the call or a timestamp indicating the time when a traffic channel was allocated for the call from the current cell. The call information comprises also an identifier sufficient to identify the first call within MSS 356. In one embodiment of the invention, at time t₁, the first call has reached target call duration, which is a predefined parameter in MSS 356. If there occurs a handover, for example, an intra BSS handover for the first call, the BSC 354 indicates to MSS 356 the current cell of mobile station 350 in a handover performed message (not shown).

At time t₂ mobile station 352, that is MS-2, detects a need to set up a second call. Incidentally, the second call must be established via the very same cell, in which the first call, which is associated with mobile station 350, that is MS-1, has a traffic channel allocated for it. In one embodiment of the invention, in its subscription information, mobile station 352 has a higher priority than mobile station 350. In one embodiment of the invention, the other alternative is that the priorities of calls that have reached the predefined target duration are demoted. In one embodiment of the invention, a pre-empted call, in other words, the call cleared in order to make its channel available for a new call, may have a priority equal to the priority of the pre-empting call, in other words, the new call for which the clearing of the pre-empted call is performed to obtain its channel. In one embodiment of the invention, another alternative is that the call set up by mobile station 352 has associated with it a higher priority due to factors that are determined during the call set up phase. An example for a priority call that is determined as a priority call during the call set up is an emergency call. Another alternative for indicating the priority of a call is to dial a prefix in front of the called party number. From the prefixed called party number it is possible to determine that the call has a priority higher than normal. In such a case MSS 356, which analyses the called party number, indicates to BSC 354 the higher priority in association with an assignment request.

At time t₂ the mobile station 352 sends a call set up message pertaining to the second call to BSC 354, as illustrated with arrow 301. BSC 354 sends the set up message further to MMS 356, as illustrated with arrow 302. Thereafter, MSS 356 determines that it has all the necessary information to set up a call further towards the called party. Due to the fact that MMS 356 has all the call information necessary for the set up of the second call, it sends a call proceeding message to BSC 354, as illustrated with arrow 303. BSC 354 sends the call proceeding message further to mobile station 352, as illustrated with arrow 304. MMS 356 sends an assignment request pertaining to mobile station 352 to BSC 354, as illustrated with arrow 305. Upon receiving the assignment request message, BSC 354 determines the cell, from which a traffic channel is required for the new call. Assuming that there are no traffic channels available, BSC 354 sends a queuing indication message to MSS 356 as illustrated with arrow 306. In response to the queuing indication message the pre-emption entity in MSS 356 checks whether in the cell there are any calls, which have reached the predefined target call duration and thus have become eligible for a soft call drop procedure wherein the call is not released until a grace period following a warning signal has elapsed. The dropping of an existing call to make way for the second call from mobile station 352 is possible by the virtue of the fact that there exists at least one call that has reached the predefined target call duration in the same cell as the second call. In the case of FIG. 3 such a call is the first call.

In one embodiment of the invention, further cases are also possible. For example, always when there occurs a handover due to traffic reasons, provided that a predefined time has elapsed, the priority of the call handed over is reduced. In one embodiment of the invention, there is no target call duration, but all calls with a priority lower than the priority of the second calls are eligible for pre-emption. In one embodiment of the invention, all calls with a priority equal to or lower than the priority of the second calls are eligible for pre-emption. In FIG. 3, after the grace period the pre-empted call is released and the traffic channel made available is allocated for the pre-empting call.

In FIG. 3 MSS 356 determines that the first call, that is, the call between mobile station 350 and media gateway 358, has reached the target call duration. MSS 356 performs the determination in the pre-emption entity, which finds the call to be pre-empted when provided with information specifying the cell in which the pre-emption must occur. The call to be pre-empted is selected based on different factors in different embodiments of the invention. In one embodiment of the invention, the longest of the calls that have reached target call duration is selected. In one embodiment of the invention, any call that has reached target call duration may be selected. In one embodiment of the invention, the call with the oldest timestamp is selected. The time stamp may specify, for example, the channel assignment of the call, the start of the call or the time when the call was handed over to its current cell. After the pre-emption entity has selected the first call, it indicates to a call control entity in MSS 356 the identity of the first call.

In response to the indication that the first call must be pre-empted, MMS 356 issues an insert tone request message to media gateway 358, which instructs media gateway 358 to connect the connection associated with the first call to a tone generator. The insert tone request message 307 is acknowledged with an acknowledgement message, as illustrated with arrow 308. As soon as a tone duration timer expires at time t₃, MMS 356 sends a remove tone message to media gateway 358 as illustrated with arrow 309, which instructs media gateway 358 to remove the tone associated with mobile station 350. The remove tone request is acknowledged with an acknowledgement message, as illustrated with arrow 310.

Upon expiry of the grace period for the first call subjected to the soft call drop procedure, MSS 356 issues a disconnect request message to BSC 354. As illustrated with arrow 312, BSC 354 sends the release message onwards to mobile station 350. As illustrated with arrow 313, mobile station 350 sends a release complete message to BSC 354. As illustrated with arrow 314, BSC 354 sends the release complete message to MSS 356. As illustrated with arrow 315, MSS 356 sends a clear command to BSC 354. BSC 354 acknowledges the clear command with a clear complete message, as illustrated with arrow 316. Due to the fact that the released traffic channel is now available for allocation to mobile station 352, BSC 354 sends an assignment complete 317 to MSS 356, as illustrated with arrow 316.

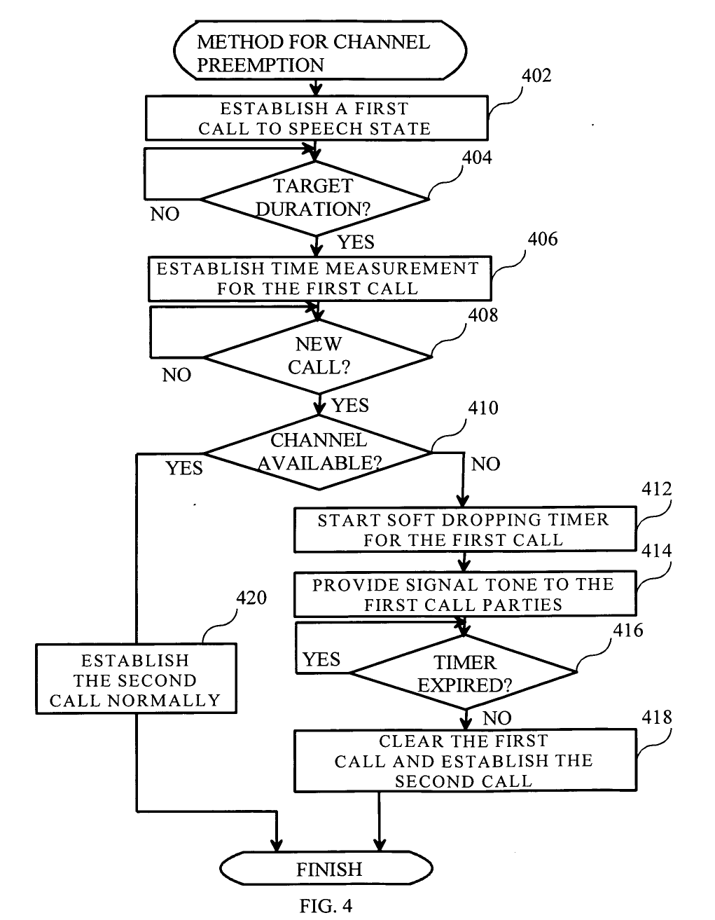

FIG. 4 is a flow chart illustrating a method for channel pre-emption in one embodiment of the invention. At step 402 a first call is established to speech state. This entails that there is a bi-directional traffic channel associated with the first call. The channel is allocated exclusively for a mobile station that is a party to the first call. The mobile station may be either the originating or the terminating party.

At step 404 in one embodiment of the invention it is checked whether the duration of the first call has exceeded a target call duration, which is required for calls eligible for pre-emption, that is, for the soft call release procedure. If the target call duration is not reached, the method continues at step 404. If the target duration is reached, the method continues at step 406. In one embodiment of the invention, at step 406 a time measurement is started for the first call. The purpose of the time measurement is to select the longest call among the pre-emption candidate calls in case a new second call arrives, for which is requiring a traffic channel from the same cell. At step 408 it is checked if a new call has arrived. If a new second call has not arrived, the method continues at step 408. If a new second call has arrived, the method continues at step 410. At step 410 it is checked, if there is a traffic channel available for the new second call from the same cell.

If a channel is available the method continues at step 420 wherein the second call is established normally and the available channel is allocated for the second call. The base station controller responsible for the cell performs the allocation. If no traffic channel is available from the required cell, the method continues at step 412. The first call is determined as subject to pre-emption. The determination utilizes information on calls associated with the cell, from which a channel is required. At step 412 a soft call drop timer is started for the first call. At step 414 in one embodiment of the invention a signal tone is provided to the call parties associated with the first call. After the signal tone has been cleared and the call parties continue in the normal speech state at step 416, it is checked if the timer for the soft call drop has expired. If the timer has not expired, the method continues at step 416 wherein the first call is still allowed to continue and the second call set up procedure awaits the availability of the channel of the first call. If the timer has expired, method continues at step 418 where the first call is released and the second call is established to the speech state using the traffic channel made available by pre-empting the first call.

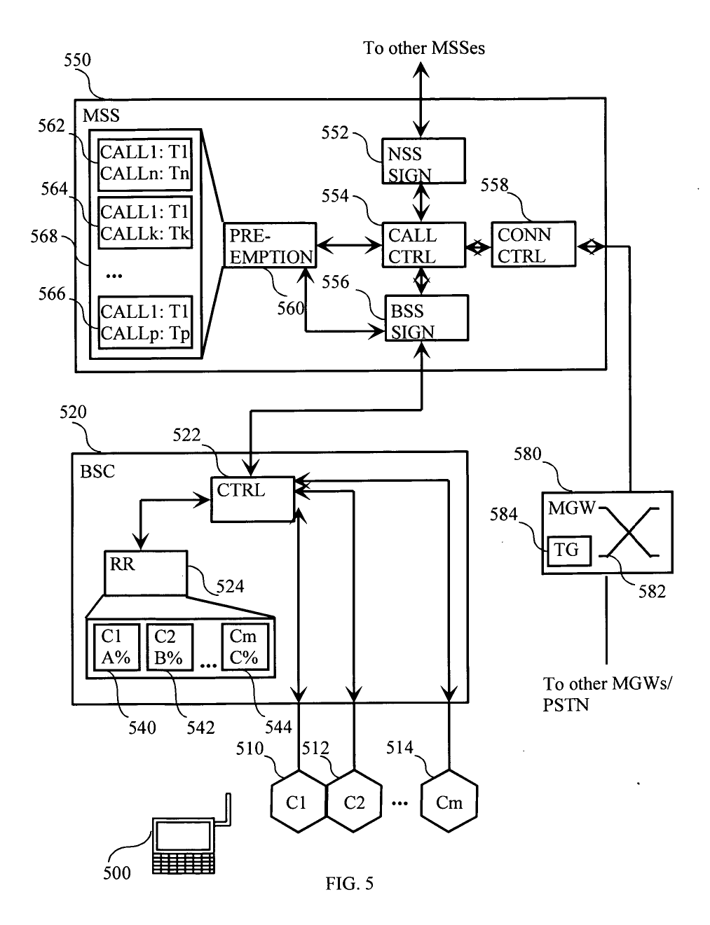

FIG. 5 illustrates a communication system employing the method for the allocation and release of channels in one embodiment of the invention. In FIG. 5 there is a mobile station 500, a base station controller 520 and an MSC server 550. Associated with BSC 520 there are a number of cells. For example cells 510, 512 and 514. The letter M stands an arbitrary integer. In BSC 520 there is a control entity 522. Control entity 522 is responsible for receiving signaling messages from MSS 550 and mobile station 500. The signaling messages are associated with, for example, radio resource allocation, modification and release and the passing of call establishment signaling between MSS 550 and mobile station 500. The signaling messages may also be associated with supplementary services, mobility management and call control between mobile station 500 and MSS 550. The signaling protocol used is, for example, the radio interface layer 3 signaling defined in the 3G Partnership Project (3GPP) specification 24.008. Control entity 522 is in communication with the base stations associated with cells 510, 512 and 514. Control entity 522 communicates also with a radio resource entity 524. Radio resource entity 524 maintains information of the allocated and available traffic channels associated with cells 510, 512 and 514. A box 540 illustrates the radio resources available in cell 510. A box 542 illustrates a radio resources available associated with cell 512. A box 544 illustrates the radio resources available in cell 514. Associated with the radio resource information maintained by radio resource entity 524 there is information indicating the mobile subscribers, for whom the traffic channels have been allocated.

Within the MSS 550 there is a network subsystem signaling entity 552, which communicates with other MSSes. There is a call control entity 554 which performs all high level call related tasks comprising, for example, call set up, maintenance and release, statistics and charging. In communication with call control entity 554 there is a connection control entity 558, which communicates with a media gateway 580. The communication occurs for example via the Megaco protocol specified in the IETF document RFC 3015. The Megaco protocol is also published as the ITU-T Recommendation H.248. Call control entity 554 communicates also with a base station subsystem signaling entity 556. In one embodiment of the invention, call control entity 554 may comprise an incoming call control entity and an outgoing call control entity. The incoming and the outgoing call control entities may further comprise a number of call control entity instances. For example, an incoming call control entity instance and an outgoing call control entity instance per a call leg. Such an instance may be a process or a thread in a virtual machine or in a native operating system.

As radio resource entity 524 determines that there are no traffic channels available from a target cell, it indicates the lack of traffic channels to control entity 522, which in turn provides a queuing indication message to MSS 550. The queuing indication message is received by BSS signaling entity 556, which in turn indicates it to call control entity 554. Call control entity 554 determines by checking the call priority that pre-emption may be performed. Call control entity indicates the need for pre-emption and the target cell identity to a pre-emption entity 560 within MSS 550. The BSS signaling entity 556 may indicate the possibility for pre-emption directly to pre-emption entity 560.

The pre-emption entity 560 performs the pre-emption of sessions. For the purposes of the disclosure of the invention at hand, the terms call and session are used interchangeably. The term session may also comprise, for example, an audio call, a video call, a multimedia call and, likewise, any other communication instance or connection, for which, a channel is allocated for a longer time period than is required, for example, for the transmission of a single short message. Pre-emption entity 560 comprises a table, which is illustrated with box 568. For each cell there is information on the calls, that is, sessions active in the cell. For each call there is recorded, for example, a call identifier, a timestamp indicating the time a channel has been allocated for the call in the cell, the actual call duration information and optionally information explicitly indicating whether the call has reached a predetermined minimum call duration to make it eligible for the soft call release procedure. By using the target cell global identifier as an index, pre-emption entity 560 is able to find the table entry associated with the cell. In FIG. 5 there is a table entry 562 indicating the calls associated with cell 510, a table entry 564 associated with calls from cell 512 and a table entry 566 associated with calls from cell 514.

Pre-emption entity 560 determines using the cell information the calls associated with the cell. Using the table entries it is able to determine the list of calls. In one embodiment of the invention, from the list of calls it determines the longest call that has reached the minimum call duration to render it eligible for pre-emption. In one embodiment of the invention, the call with the oldest timestamp is determined. The call determined becomes the target for the soft call drop procedure. Using the call information and the call identifier, pre-emption entity 560 is able to determine the call subjected to the soft call drop procedure. In one embodiment of the invention, the call identifier is used to address a call control process or a thread in MSS 550 responsible for processing the call to be dropped. Pre-emption entity 560 sends a message to call control entity 554, which indicates to call control entity 554 that the call should be dropped in a specified time and that the parties to that call should be notified. In response, call control entity 554 requests connection control entity 558 to further request media gateway 580 to connect a warning signal to the parties of the call to be dropped. After the warning signal duration is reached, call control entity 554 requests connection control entity 558 to further request media gateway 580 to disconnect the warning signal and reconnect the call parties. Call control entity 554 allows the call to continue during a grace period. After the grace period, the call is released by call control entity 554.

In media gateway 580 there is a tone generator 584 and a switching entity 582. Switching entity 582 is, for example, a switching matrix or a switching memory. It is for the purposes of connecting an input and output port for the transmission of user plane media paths. In response to connection control requests from connection control entity 558 media gateway 580 manages the connections associated, for example, it may command the circuit associated with the call to be connected to the tone generator. Similarly, media gateway 580 may also release connections towards base station controllers and to other media gateways and also perform the allocation of new similar connections. In association with a MSS there is also a visitor location register (not shown).

The entities within the session control node and the radio node, that is, NSS signaling entity 552, call control entity 554, BSS signaling entity 556, connection control entity 558, pre-emption entity 560, control entity 522 and radio resource entity 524 in FIG. 5 may be implemented in various ways. They may be implemented as processes executed under the native operating system. The software entities may be implemented as separate processes or so that a number of different software entities is implemented by means of one process. A process may be the instance of a program block comprising a number of routines, that is, for example, procedures and functions. The entities may be implemented as separate computer programs or as a single computer program. The program blocks are stored on at least one computer readable medium such as, for example, a memory circuit, memory card, magnetic or optic disk. Some software entities may be implemented as modules linked to another entity. The entities may be stored or executed in separate computer units, which communicate via a message bus or a network. A computer unit comprises as its components, for example, a processor, a random access memory, a secondary memory such as a magnetic or optical disk or a flash memory card and a communication interface. A computer unit may be comprised in a blade server or in a rack system together with other computer units. A computer unit may also, for example, be a desktop computer, workstation or a portable computer. In one embodiment of the invention, a set of computer units may be used together to form a part of a network element, for example, BSC 520 or MSS 550. In one embodiment of the invention, a single computer may also provide a network element such as BSC 520 or MSS 550. The information on session associated with a cell may be stored, for example, as a data structure such as a table or a tree stored in random access memory.

In one embodiment of the invention, BSS signaling entity 556 and pre-emption entity 560 may be merged as a single entity. Those entities may further be comprised in the control entity 554. Pre-emption entity 560 may also be provided as part of call control entity 554.

In one embodiment of the invention, a pre-emption entity similar to pre-emption entity 560 is provided in BSC 520. The pre-emption entity within BSC 520 is contacted by radio resource entity 524 upon the noticing of the the lack of traffic channel from the target cell. Thereupon, the pre-emption entity within BSC 520 contacts control entity 522, which provides an indication of a required warning signal to the call parties towards MSS 550. In response, MSS 550 connects the warning signal via MGW 580 to the call parties of the call to be dropped. Upon, the expiry of the grace period the call is dropped MSS 550 or BSC 520.

It is obvious to a person skilled in the art that with the advancement of technology, the basic idea of the invention may be implemented in various ways. The invention and its embodiments are thus not limited to the examples described above; instead they may vary within the scope of the claims.

1. A method for an allocation and a release of channels in a communication system comprising at least a first mobile node, a second mobile node, a session control node and a radio node, the method comprising:
establishing a first session associated with said first mobile node via said radio node and said session control node to a conversation state, said first session using a first channel within a first cell;
starting an establishment of a second session associated with said second mobile node in said first cell;
determining in said radio node a lack of available channels in said first cell for said second session;
selecting in said session control node said first session for dropping;
providing a warning signal to at least one party associated with said first session;
releasing said first session; and
allocating said first channel for said second session in said radio node.

2. The method according to claim 1, the method further comprising:
allowing the first session to continue a predefined time after said providing of said warning signal; and
releasing said first session in response to the elapsing of said predefined time.

3. The method according to claim 1, the method further comprising:
determining a first priority for said first session;
determining a second priority for said second session; and
checking that the second priority is equal to or higher than the first priority before selecting said first session for dropping.

4. The method according to claim 1, the method further comprising:
determining in said session control node that a priority for said first session does not exceed a predefined priority;
determining in said session control node that said first session has exceeded a minimum session duration time; and
providing said first session as a candidate for session drop.

5. The method according to claim 1, the method further comprising:
recording an allocation time for said first session in said session control node;
comparing the allocation time for said first session to the allocation time for at least one third session in said session control node; and
selecting in said session control node said first session for dropping if the allocation time of said first session is longer than the allocation time of said at least one third session.

6. The method according to claim 5, wherein said allocation time comprises a timestamp indicating a time a channel is allocated for said session in a given cell.

7. The method according to claim 5, wherein said allocation time comprises a time indicating a duration of said session.

8. The method according to claim 1, the method further comprising:
setting a priority for said first session based on subscriber data associated with said first mobile node;
determining in said session control node that said first session has exceeded a minimum session duration time; and
demoting the priority for said first session in response to the exceeding of the minimum session duration time.

9. The method according to claim 8, the method further comprising:
demoting the priority for said first session at least once in every predefined priority demotion period.

10. The method according to claim 1, the method further comprising:
performing a handover due to traffic conditions for said first session; and
demoting the priority for said first session in response to the handover if a second predefined time has elapsed.

11. The method according to claim 1, wherein said communication system comprises a Wireless Local Area Network.

12. The method according to claim 1, wherein said mobile communication system comprises at least one of a Global System of Mobile Communications network and a Universal Mobile Telephone System network.

13. The method according to claim 12, wherein said radio node comprises a Base Station Controller or a Radio Network Controller.

14. The method according to claim 12, wherein said session control node comprises a Mobile Service Switching center Server.

15. A method for an allocation and a release of channels in a communication system comprising at least a first mobile node, a second mobile node, a session control node and a radio node, the method comprising:
establishing a first session associated with said first mobile node via said radio node and said session control node to a conversation state, said first session using a first channel within a first cell;
recording an allocation time for said first session in said session control node;
starting an establishment of a second session associated with said second mobile node in said first cell;
determining in said radio node a lack of available channels in said first cell for said second session;
comparing the allocation time for said first session to the allocation time for at least one third session in said session control node;
when the allocation time of said first session is longer than the allocation time of said at least one third session, selecting in said session control node said first session for dropping;
releasing said first session; and
allocating said first channel for said second session in said radio node.

16. The method according to claim 15, wherein said allocation time comprises a timestamp indicating a time a channel is allocated for said session in a given cell.

17. The method according to claim 15, wherein said allocation time comprises a time indicating the time said session has lasted.

18. A system comprising:
a session control node configured to establish a first session associated with a first mobile node to a conversation state, said first session using a first channel within a first cell, to receive an indication of the establishment of a second session associated with a second mobile node in said first cell, to receive an indication of a lack of an available channel in said first cell for said second session, to request a warning signal to at least one party associated with said first session in response to said indication, to select said first session for dropping, to release said first session and to allocate said first channel for said second session.

19. The system according to claim 18, the system further comprising:
said session control node configured to allow the first session to continue a predefined time after the requesting of said warning signal and to release said first session in response to an elapse of said predefined time.

20. The system according to claim 18, the system further comprising:
said session control node configured to determine a first priority for said first session, to determine a second priority for said second session and to check that the second priority is equal to or higher than the first priority before selecting said first session for dropping.

21. The system according to claim 18, the system further comprising:
said session control node configured to determine that a priority for said first session does not exceed a predefined priority, to determine that said first session exceeds a minimum session duration time and to select said first session as a candidate for session drop.

22. The system according to claim 18, the system further comprising:
said session control node configured to record an allocation time for said first session, to compare the allocation time for said first session to the allocation time for at least one third session and to select said first session for dropping when the allocation time of said first session is longer than the allocation time of said at least one third session.

23. The system according to claim 22, wherein said allocation time comprises a timestamp indicating a time a channel is allocated for said session in a given cell.

24. The system according to claim 22, wherein said allocation time comprises a time indicating the time said session has lasted.

25. The system according to claim 18, wherein
said session control node is configured to set a priority for said first session based on subscriber data associated with said first mobile node, to determine in said radio node that said first session has exceeded a minimum session duration time and to demote the priority for said first session in response to the exceeding of the minimum session duration time.

26. The system according to claim 18, wherein
said radio node is configured to perform a handover due to traffic conditions for said first session, and
said session control node is configured to demote the priority for said first session in response to the handover if a second predefined time has elapsed.

27. The system according to claim 18, wherein said system comprises a Wireless Local Area Network.

28. The system according to claim 18, wherein said system comprises at least one of a Global System of Mobile Communications network and a Universal Mobile Telephone System network.

29. The system according to claim 28, wherein said radio node comprises a Base Station Control or a Radio Network Controller.

30. The system according to claim 28, wherein said call control node comprises a Mobile Service Switching center Server.

31. A system comprising:
a session control node configured to establish a first session associated with a first mobile node to a conversation state, said first session using a first channel within a first cell, to record an allocation time for said first session, to start an establishment of a second session associated with a second mobile node in said first cell, to receive an indication of lack of available channels in said first cell for said second session, to compare the allocation time for said first session to the allocation time for at least one third session, to select said first session for dropping in response to the allocation time of said first session indicating longer time than the allocation time of said at least one third session, to release said first session and to allocate said first channel for said second session via a radio node.

32. The system according to claim 31, wherein said allocation time comprises a timestamp indicating a time a channel is allocated for said session in a given cell.

33. The system according to claim 31, wherein said allocation time comprises a time indicating the duration of said session.

34. A network node comprising:
a call control entity configured to establish a first session associated with a first mobile node to a conversation state, said first session using a first channel within a first cell, to receive an indication of an establishment of a second session associated with a second mobile node in said first cell, to receive an indication of lack of available channels in said first cell for said second session, to request a warning signal to at least one party associated with said first session in response to said indication and to release said first session; and
a pre-emption entity configured to select said first session for dropping based on information on said first cell.

35. A network node comprising:
a call control entity configured to establish a first session associated with a first mobile node to a conversation state, said first session using a first channel within a first cell, to start an establishment of a second session associated with a second mobile node in said first cell, to receive an indication of lack of available channels in said first cell for said second session, to release said first session and to allocate said first channel for said second session via a radio node; and
a pre-emption entity configured to record an allocation time for said first session, to compare the allocation time for said first session to the allocation time for at least one third session, to select said first session for dropping in response to the allocation time of said first session indicating longer time than the allocation time of said at least one third session.

36. A network node comprising:
means for establishing a first session associated with a first mobile node to a conversation state, said first session using a first channel within a first cell;
means for receiving an indication of the establishment of a second session associated with a second mobile node in said first cell;
means for determining a lack of available channels in said first cell for said second session;
means for selecting said first session for dropping;
means for releasing said first session; and
means for allocating said first channel for said second session.

37. A network node comprising:
means for establishing a first session associated with a first mobile node to a conversation state, said first session using a first channel within a first cell;
means for recording an allocation time for said first session;
means for starting an establishment of a second session associated with a second mobile node in said first cell;
means for receiving an indication of lack of available channels in said first cell for said second session;
means for comparing an allocation time for said first session to the allocation time for at least one third session;
means for selecting said first session for dropping in response to the allocation time of said first session indicating longer time than the allocation time of said at least one third session;
means for releasing said first session; and
means for allocating said first channel for said second session via a radio node.

38. A computer program embodied on a computer readable medium, the computer program being configured to perform the steps of:
establishing a first session associated with a first mobile node to a conversation state, said first session using a first channel within a first cell;
receiving an indication of an establishment of a second session associated with a second mobile node in said first cell;
determining a lack of available channels in said first cell for said second session;
selecting said first session for dropping;
releasing said first session; and
allocating said first channel for said second session.

39. The computer program according to claim 30, wherein said computer readable medium is a magnetic disk.

40. The computer program according to claim 31, wherein said computer readable medium is a removable memory card.

41. The computer program according to claim 31, wherein said computer readable medium is an optical disk.

42. A computer program embodied on a computer readable medium, the computer program being configured to perform the steps of:
establishing a first session associated with a first mobile node to a conversation state, said first session using a first channel within a first cell;
recording an allocation time for said first session;
starting an establishment of a second session associated with a second mobile node in said first cell;
receiving an indication of a lack of available channels in said first cell for said second session
comparing the allocation time for said first session to the allocation time for at least one third session;
selecting said first session for dropping in response to the allocation time of said first session indicating longer time than the allocation time of said at least one third session;
releasing said first session; and
allocating said first channel for said second session via a radio node.

43. The computer program according to claim 42, wherein said computer readable medium is a magnetic disk.

44. The computer program according to claim 43, wherein said computer readable medium is a removable memory card.

45. The computer program according to claim 43, wherein said computer readable medium is an optical disk.
